(19) United States
(12) Patent Application Publication
(10) Pub. No.: US 2008/0013538 A1
(43) Pub. Date: Jan. 17, 2008

(54) Method of transmitting neighbor discovery protocol message in IEEE 802.16/Wibro network

(76) Inventors: Joo Chul Lee, Daejeon-city (KR); Myung Ki Shin, Daejeon-city (KR); Sangjin Jeong, Daejeon-city (KR); Hyoung Jun Kim, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/635,936

(22) Filed: Dec. 8, 2006

(30) Foreign Application Priority Data
Jul. 11, 2006 (KR) 10-2006-0065071

(51) Int. Cl. H04L 12/56

(52) U.S. Cl. 370/390

(57) ABSTRACT

A method of transmitting a neighbor discovery protocol (NDP) message in an IEEE 802.16/Wibro network is provided. The method of transmitting an NDP message in a sub-network formed with access routers and a plurality of base stations connected to the access router through separate interfaces includes: a first base station transmitting a first NDP message received from a first terminal, to the access router; and the access router transmitting the first NDP message to the remaining base stations excluding the first base station. According to the method, a method of processing an NDP message in an environment having multiple base stations which cannot be considered under a conventional environment using a multicast connection ID (CID) can be improved, and problems that can occur when a IPv6 is introduced in an IEEE 802.16/Wibro network can be solved.

### CROSS-REFERENCE TO RELATED PATENT APPLICATIONS

This application claims the benefit of Korean Patent Application No. 10-2006-0065071, filed on Jul. 11, 2006, in the Korean Intellectual Property Office, the disclosure of which is incorporated herein in its entirety by reference.

### BACKGROUND OF THE INVENTION

1. Field of the Invention

The present invention relates to a method of supporting multicasting under a multiple base station environment, and more particularly, to a method of transmitting a neighbor discovery protocol (NDP) message in an IEEE 802.16/Wibro network.

2. Description of the Related Art

An IEEE 802.16 protocol is a protocol for a physical layer and a medium access control (MAC) layer for a new wireless broadband network. An IEEE 802.16/Wibro network is generally formed of base stations, subscriber stations and access routers. In IEEE 802.16/Wibro networks, the IEEE 802.16 protocol is applied to the sections between a base station and a subscriber station. Basically, the IEEE 802.16 employs a point-to-multipoint type connection and does not support multicast in a MAC layer unlike an IEEE 802.3 protocol. Accordingly, in the case of an IPv6 NDP protocol which relies heavily on multicast support in the MAC layer, it is difficult to apply a IPv6 NDP protocol directly to the IEEE 802.16/Wibro network.

Conventional methods to solve this problem are as follows.

First, there is a multiple unicast method. According to this method, a base station has a list of all subscriber stations belonging to a predetermined multicast group, and the base station receiving a packet transmitted to this multicast group copies the packet and transmits the packet to each of the subscriber stations belonging to the multicast group through a unicast method.

Secondly, a multicast connection identifier (ID) method can be used. According to this method, a connection ID (CID) is allocated to each predetermined multicast group. Subscriber stations that are members of each multicast group join in this CID. Here, the joining of the CID means that members of a multicast group are assigned a CID used for multicast transmission under the IEEE 802.16/Wibro environment. If a base station receives a packet with a destination of a predetermined multicast address, the base station transmits the packet to the multicast group by using the CID allocated to the multicast group. The packet transmitted this way is transferred to all subscriber stations joining in this CID, and this is performed by one transmission of the packet.

If this method is applied to an NDP, 3 multicast connection IDs, including an all-node multicast CID, an all-router multicast CID, and a solicited-node multicast CID, are required.

The NDP is a core protocol of the IPv6 protocol and provides address autoconfiguration, address resolution and algorithms related to packet transmission. Accordingly, without the NDP, the IPv6 protocol cannot be implemented correctly. Meanwhile, most of messages used in the NPD require multicast support in the lower layers due to the characteristics of the role of the NDP. Accordingly, it is difficult to apply the IPv6 protocol directly to an IEEE 802.16 network.

### SUMMARY OF THE INVENTION

The present invention provides a method of transmitting a neighbor discovery protocol (NDP) message in a sub-network environment formed of a plurality of base stations.

The present invention also provides a computer readable recording medium having embodied thereon a computer program for executing the method of transmitting the NDP message.

According to an aspect of the present invention, there is provided a method of transmitting a neighbor discovery protocol (NDP) message in a sub-network formed with access routers and a plurality of base stations connected to the access router through separate interfaces, in an IEEE 802.16/Wibro network, the method including: a first base station transmitting a first NDP message received from a first terminal, to the access router; and the access router transmitting the first NDP message to the remaining base stations excluding the first base station.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a structure of a conventional IEEE 802.16/Wibro network;

FIGS. 2 and 3 are diagrams illustrating examples of sub-networks in an IEEE 802.16/Wibro network to which an embodiment of the present invention is applied;

FIGS. 4A through 4D are flowcharts illustrating methods of transmitting a neighbor discovery protocol (NDP) message in a sub-network structure, as illustrated in FIG. 2, according to embodiments of the present invention; and

FIGS. 5A through 5D are flowcharts illustrating methods of transmitting an NDP message in a sub-network structure, as illustrated in FIG. 3, according to embodiments of the present invention.

### DETAILED DESCRIPTION OF THE INVENTION

The present invention will now be described more fully with reference to the accompanying drawings, in which exemplary embodiments of the invention are shown.

In essence, an IEEE 802.6 network does not support a multicast method in a medium access control (MAC) layer which is supported in an IEEE 802.3 network. Accordingly, it is difficult to apply a protocol, such as an IPv6 neighbor discovery protocol (NDP), which relies heavily on this multicast method, directly to an IEEE 802.16 network. To solve this, several methods to support multicast on an IEEE 802.16 network have been suggested. In the present invention, suggested is a method of processing an NDP message when a method using multicast connection ID (CID) among the several methods is employed and multiple base stations (BSs) are applied.

That is, according to the present invention as a method to support multicast in an IEEE 802.16/Wibro network, even when a method of supporting multicast by using a multicast CID is applied to a multiple base station environment, an NDP message can be transmitted to a desired receiver.

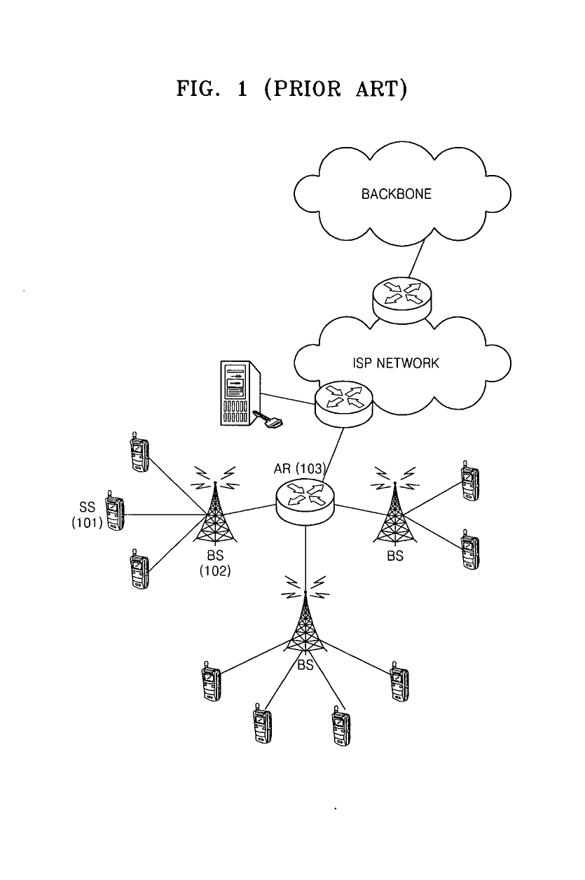

FIG. 1 is a diagram illustrating a structure of a conventional IEEE 802.16/Wibro network.

The IEEE 802.16/Wibro network is generally composed of base stations (BSs) 102, subscriber stations (SSs) 101, and access routers (ARs) 103, as an example illustrated in FIG. 1 shows. Referring to FIG. 1, the IEEE 802.16/Wibro network includes the SSs 101 that support the IEEE 802.16 protocol, the BSs 102 that controls and manages connections to the SSs 101, and the ARs 103 that transmit traffic received through the BS 102 to an Internet backbone network. In this network structure, the present invention relates to a method of processing an NDP message with respect to the physical connection states of the BSs 102 and the ARs 103, and the structure of a sub-network formed between the ARs, the BSs, and the SSs.

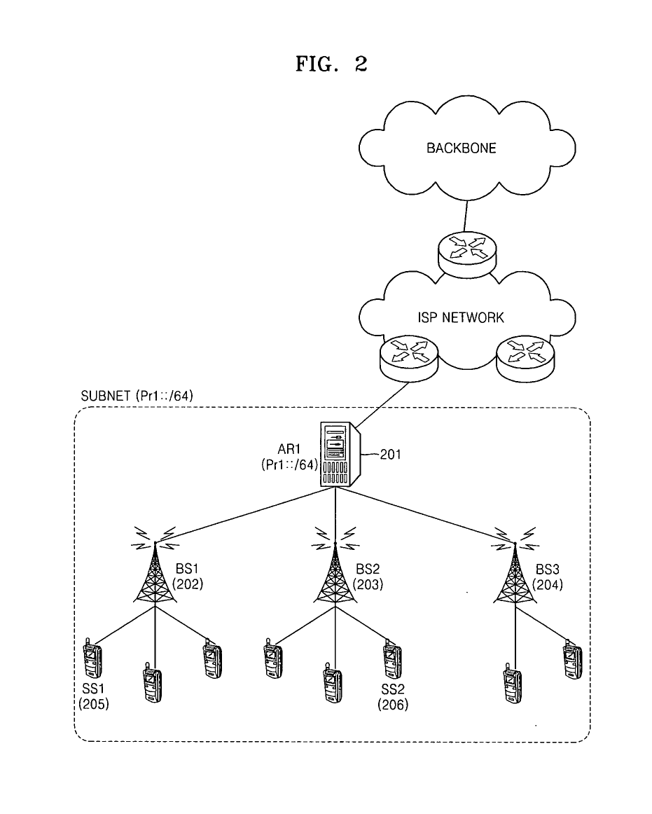

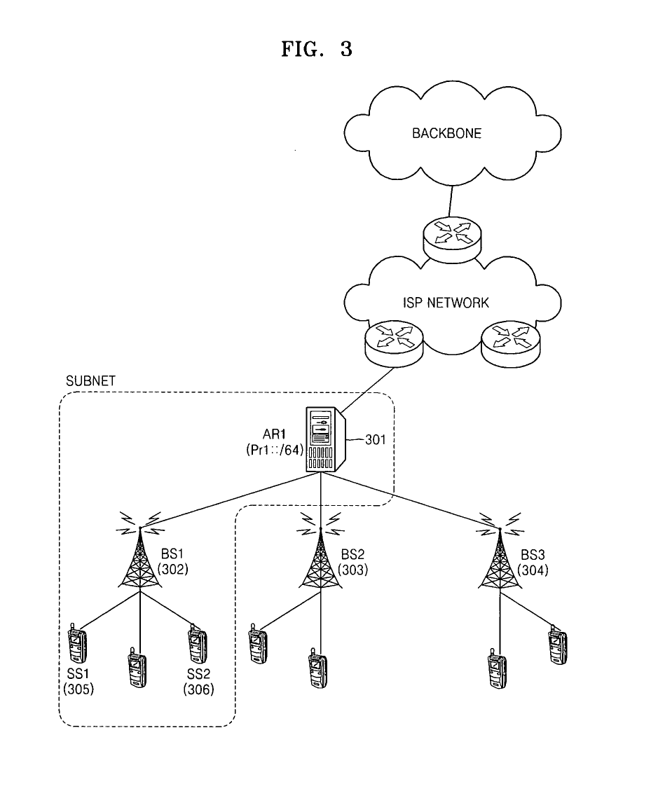

FIGS. 2 and 3 are diagrams illustrating examples of sub-networks in an IEEE 802.16/Wibro network to which an embodiment of the present invention is applied.

FIG. 2 is a diagram illustrating a sub-network formed with one AR 201, 2 or more BSs 202, 203, and 204, and SSs 205 and 206 independently belonging to one of the BSs 202, 203, and 204. According to the structure of the sub-network of FIG. 2, the BSs 202, 203 and 204 are connected to different interfaces of the AR 201, and the interfaces of the AR 201 connected to the BSs 202, 203, and 204 are linked to each other through bridges.

FIG. 3 is a diagram illustrating a sub-network formed with one AR 301, one BS 302, and two SSs 305 and 306 belonging to this BS 302.

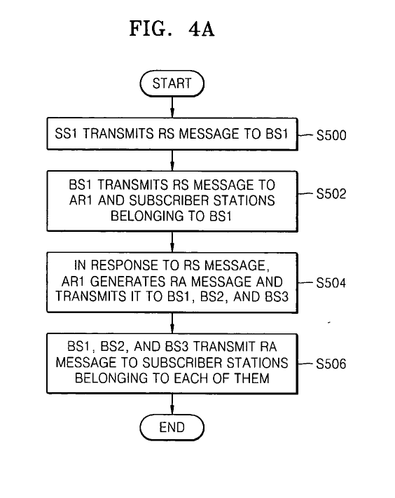

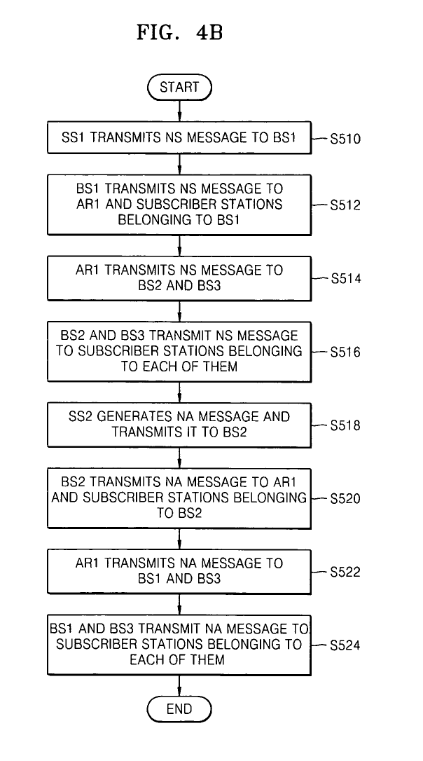

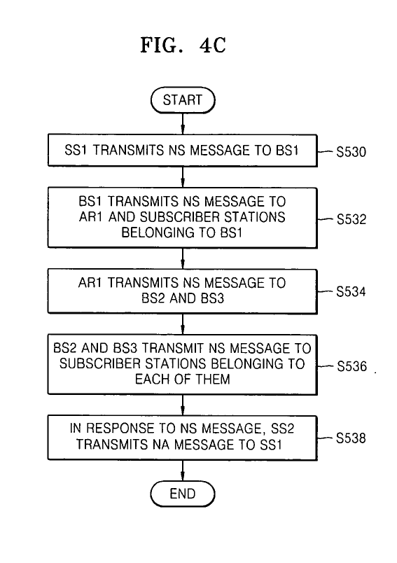

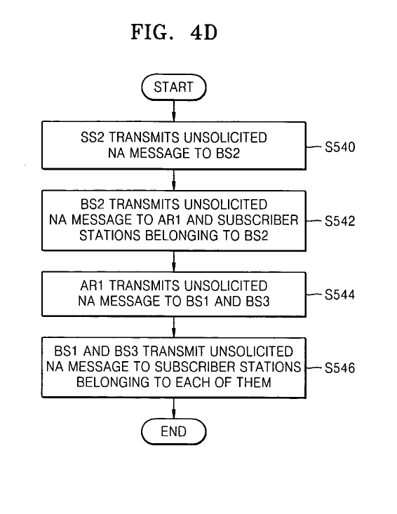

FIGS. 4A through 4D are flowcharts illustrating methods of transmitting an NDP message in a sub-network structure, as illustrated in FIG. 2, according to embodiments of the present invention.

FIG. 4A is a flowchart illustrating a method of transmitting an NDP message for address autoconfiguration according to an embodiment of the present invention in the sub-network structure as illustrated in FIG. 2.

The address autoconfiguration process is a process in which an IPv6 node automatically generates global and/or site-local and/or link-local addresses. At this time, the global address or the site-local address is generated using a prefix allocated by a router and the link-local address is generated using MAC address information of an interface. Accordingly, since a separate message exchange for address generation is not performed in the process of automatically generating a link-local address, the explanation will be omitted and only the process of automatically setting global and/or site-local addresses will be described with reference to FIG. 2. Here, it is assumed that the SS 205 automatically sets an address.

In operation S500, in order to obtain a prefix for address autoconfiguration of global and/or site-local addresses, SS1 205 transmits a router solicitation (RS) message having an all-router multicast address as a destination address, to BS1 202.

In operation S502, by using a multicast CID method, BS1 202 transmits the RS message received from SS1 205, to all SSs joining in the all-router multicast among the SSs connected to BS1 202. Meanwhile, since the RS message is set to be transmitted to all routers, BS1 202 also transmits the RS message to AR1 201.

In operation S504, in response to the received RS message, AR1 201 generates a router advertisement (RA) message including prefix information, and transfers the generated message to BSs 202, 203 and 204. Here, the destination address of the RA message is an all-node multicast address.

In operation S506, by using the multicast CID method, the BSs 202, 203 and 204 transmit the RA message to all SSs connected to one of the BSs 202, 203, and 204. Then, SS1 205 or other SSs belonging to the sub-network generate global and/or site-local addresses using the prefix included in the RA message.

FIG. 4B is a flowchart illustrating a method of transmitting an NDP message for duplicate address detection according to an embodiment of the present invention in the sub-network structure as illustrated in FIG. 2.

The duplicate address detection is a process for examining whether or not the global and/or site-local and/or link-local addresses generated through the address autoconfiguration uses the address of another SS. In the following description referring to FIG. 2, it is assumed that SS1 205 performs address autoconfiguration and then duplication address detection while SS2 206 uses the same address as that generated by the address autoconfiguration.

In operation S510, in order to perform duplicate address detection, SS1 205 transmits a neighbor solicitation (NS) message to BS1 202. Here, the destination address of the NS message is a solicited-node multicast address.

In operation S512, by using a multicast CID method, BS1 202 transmits the NS message to SSs joining in the solicited-node multicast CID. Also, in order to transmit the NS message to other SSs belonging to the same sub-network, BS1 202 also transmits the NS message to AR1 201.

In operation S514, AR1 201 transfers the NS message to the remaining base stations, BS2 203 and BS3 204, excluding BS1 202.

In operation S516, BS2 203 and BS3 204 transmit the NS message to SSs joining in the solicited-node multicast, by using a multicast CID method.

In operation S518, in response to SS2 206 receiving the NS message, SS2 206 generates a neighbor advertisement (NA) message and transmits the NA message to BS2 203. Here, the destination address of the NA message is an all-node multicast address.

In operation S520, by using the multicast CID method, BS2 203 transmits the NA message to SSs connected to BS2 203. Also, in order to transmit the NA message to other BSs 202 and 204 belonging to the same sub-network, BS2 203 transmits the NA message to AR1 201.

In operation S522, AR1 201 transmits the NA message to BS1 202 and BS3 204.

In operation S524, by using a multicast CID method, BS1 202 and BS3 204 transmit the NA message to SSs connected to each of them. Then, SS1 205 detects through the received NA message that the address generated by SS1 205 is a duplicate address.

FIG. 4C is a flowchart illustrating a method of transmitting an NDP message for address resolution according to an embodiment of the present invention in the sub-network structure as illustrated in FIG. 2. The address resolution is a process of obtaining a MAC address of a destination station. In the following description referring to FIG. 2, it is assumed that SS1 205 wants to obtain the MAC address of SS2 206.

In operation S530, in order to obtain the MAC address of SS2 206, SS1 205 transmits an NS message to BS1 202. Here, the destination address of the NS message is a solicited node multicast address.

In operation S532, BS1 202 transmits the received NS message to SSs joining in the solicited node multicast, by using a multicast CID method. Also, in order to also transfer the NS message to other SSs belonging to the same sub-network, BS1 202 transmits the NS message to AR1 201.

In operation S534, AR1 201 transmits the NS message to BS2 203 and BS3 204.

In operation S536, BS2 203 and BS3 204 transmit the received NS message to SSs belonging to each of them, by using a multicast CID method.

In operation S538, in response to the received NS message, SS2 206 transmits a neighbor advertisement (NA) message including its MAC address, to SS1 205. Here, the NA message has the address of SS1 205 as a destination address and is transmitted through BS2 203 and BS1 202 using a unicast method. Then, SS1 205 obtains the MAC address of SS2 206 through the NA message.

FIG. 4D is a flowchart illustrating a method of transmitting an NDP message for neighbor unreachability detection according to an embodiment of the present invention in the sub-network structure as illustrated in FIG. 2. The neighbor unreachability detection is a process of examining whether or not the contents of a neighbor cache are available before the contents of the neighbor are referred to in a pack transmission algorithm using an NDP. In the following description referring to FIG. 2, it is assumed that SS1 205 examines the contents of a neighbor cache in relation to SS2 206.

Since an NS message and NA message to be exchanged in the process of neighbor unreachability detection are all transmitted using a unicast method, they do not relate to the scope of the present invention. Meanwhile an unsolicited NA message which is used by an IPv6 node to notify that its MAC address has changed is transmitted with an all-node multicast address as a destination address. Accordingly, only this case will be described below.

In operation S540, SS2 206 transmits an unsolicited NA message to BS2 203. Here, the destination address of the unsolicited NA message is an all-node multicast address.

In operation S542, BS2 203 transmits the unsolicited NA message to SSs connected to BS2 203, by using a multicast CID method. Also, in order to transfer the unsolicited NA message to the other BSs 202 and 204 belonging to the same sub-network, BS2 203 transmits the unsolicited NA message to AR1 201.

In operation S544, AR1 201 transmits the unsolicited NA message to BS1 202 and BS3 204.

In operation S546, BS1 202 and BS3 204 transfer the unsolicited NA message to SSs belonging to each of them by using a multicast CID method.

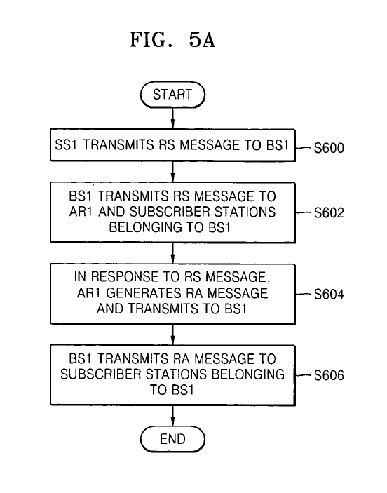

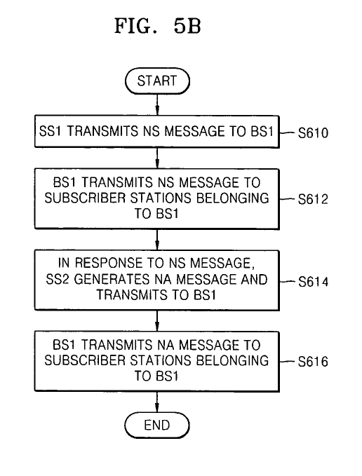

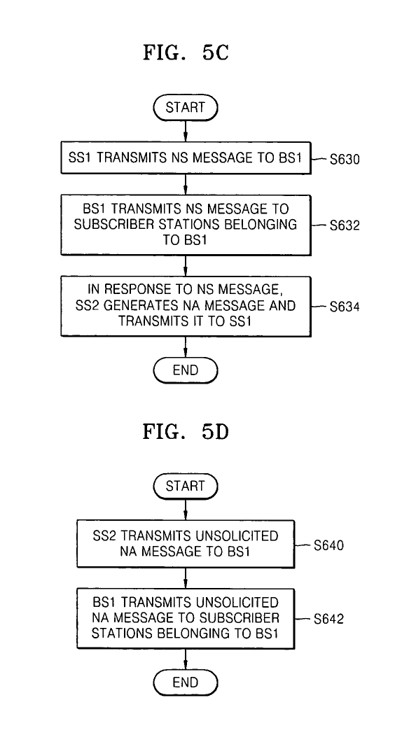

FIGS. 5A through 5D are flowcharts illustrating methods of transmitting an NDP message in a sub-network structure as illustrated in FIG. 3, according to embodiments of the present invention.

FIG. 5A is a flowchart illustrating a method of transmitting an NDP message for address autoconfiguration according to an embodiment of the present invention in the sub-network structure as illustrated in FIG. 3. In the following description referring to FIG. 3, it is assumed that SS1 305 performs address autoconfiguration.

In operation S600, in order to obtain a prefix for address autoconfiguration of global and/or site-local addresses, SS1 305 transmits an RS message having an all-router multicast address as a destination address, to BS1 302.

In operation S602, by using a multicast CID method, BS1 302 transmits the RS message received from SS1 305, to SSs joining in the all-router multicast among SSs connected to BS1 302. Meanwhile, since the RS message is set to be transmitted to all routers, BS1 302 also transmits the RS message to AR1 301.

In operation S604, in response to the received RS message, AR1 301 generates an RA message including prefix information, and transfers the generated message to BS 302. Here, the destination address of the RA message is an all-node multicast address.

In operation S606, by using a multicast CID method, the BS1 302 transmits the RA message to SSs connected to the BS1 302. Then, SS1 305 or other SSs belonging to the sub-network generate global and/or site-local addresses using the prefix information included in the RA message.

FIG. 5B is a flowchart illustrating a method of transmitting an NDP message for duplicate address detection according to an embodiment of the present invention in the sub-network structure as illustrated in FIG. 3. In the following description referring to FIG. 3, it is assumed that SS1 305 performs address autoconfiguration and then duplication address detection while SS2 306 uses the same address as that generated by the address autoconfiguration.

In operation S610, in order to perform duplicate address detection, SS1 305 transmits an NS message to BS1 302. Here, the destination address of the NS message is a solicited-node multicast address.

In operation S612, by using a multicast CID method, BS1 302 transmits the NS message to SSs joining in the solicited-node multicast CID.

In operation S614, in response to SS2 306 receiving the NS message, SS2 306 generates an NA message and transmits the NA message to BS1 302. Here, the destination address of the NA message is an all-node multicast address.

In operation S616, by using a multicast CID method, BS1 302 transmits the NA message to SSs connected to BS1 302. Then, SS1 305 detects through the received NA message that the address generated by SS1 305 is a duplicate address.

FIG. 5C is a flowchart illustrating a method of transmitting an NDP message for address resolution according to an embodiment of the present invention in the sub-network structure as illustrated in FIG. 3. The address resolution is a process of obtaining a MAC address of a destination station. In the following description referring to FIG. 3, it is assumed that SS1 305 wants to obtain the MAC address of SS2 306.

In operation S630, in order to obtain the MAC address of SS2 306, SS1 305 transmits an NS message to BS1 302. Here, the destination address of the NS message is a solicited node multicast address.

In operation S632, BS1 302 transmits the received NS message to SSs joining in the solicited node multicast, by using the multicast CID method.

In operation S634, in response to the received NS message, SS2 306 transmits an NA message including its MAC address, to SS1 305. Here, the NA message has the address of SS1 305 as a destination address and is transmitted through BS1 302 in a unicast method. Through this process, BS1 305 obtains the MAC address of SS2 306 through the NA message.

FIG. 5D is a flowchart illustrating a method of transmitting an NDP message for neighbor unreachability detection according to an embodiment of the present invention in the sub-network structure as illustrated in FIG. 3. In the following description referring to FIG. 3, it is assumed that SS1 305 examines the contents of a neighbor cache in relation to SS2 306.

Since an NS message and NA message exchanged in the process of neighbor unreachability detection are transmitted all in a unicast method, they do not relate to the scope of the present invention. Meanwhile an unsolicited NA message which is used by an IPv6 node to notify that its MAC address has changed is transmitted with an all-node multicast address as a destination address. Accordingly, only this case will now be described.

In operation S640, SS2 306 transmits an unsolicited NA message to BS1 302. Here, the destination address of the unsolicited NA message is an all-node multicast address.

In operation S642, BS1 302 transmits the unsolicited NA message to SSs connected to BS1 302, by using a multicast CID method.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

According to the present invention, even under in an IEEE 802.16/Wibro network having multiple base stations, multicast transmission is enabled and through a multicast method an NDP message can be transmitted. As a result, problems that can occur when an IPv6 is introduced in the IEEE 802.16/Wibro network can be solved.

What is claimed is:

1. A method of transmitting a neighbor discovery protocol (NDP) message in a sub-network formed with access routers and a plurality of base stations connected to the access router through separate interfaces in an IEEE 802.16/Wibro network, the method comprising:
a first base station transmitting a first NDP message received from a first subscriber station, to the access router; and
the access router transmitting the first NDP message to the remaining base stations excluding the first base station.

2. The method of claim 1, further comprising:
the access router transmitting a second NDP message corresponding to the first NDP message to all base stations of the sub-network.

3. The method of claim 2, further comprising:
all base stations of the sub-network transmitting the second NDP message to subscriber stations belonging to a multicast group corresponding to a multicast address of the second NDP message.

4. The method of claim 1, further comprising:
all base stations of the sub-network transmitting the first NDP message to subscriber stations belonging to a multicast group corresponding to a multicast address of the first NDP message.

5. The method of claim 3, wherein the transmitting of the second NDP message to the subscriber stations belonging to the multicast group comprises transmitting the second NDP message by using a multicast connection identifier corresponding to the multicast address.

6. The method of claim 2, wherein the first NDP message is a router solicitation message for address autoconfiguration which includes an all-router multicast address, and
the second NDP message is a router advertisement message which is generated by the access router in response to the first NDP message and includes an all-node multicast address and the prefix of the sub-network.

7. The method of claim 2, wherein the first NDP message is a neighbor solicitation message for duplicate address detection and includes a solicited-node multicast address, the second NDP message is a neighbor advertisement message including an all-node multicast address, and
the transmitting of the second NDP message comprises:
a second base station transmitting an NDP message, which is generated by a second subscriber station in response to the first NDP message, to the access router; and
the access router transmitting the NDP message to all base stations of the sub-network.

8. The method of claim 1, further comprising transmitting a neighbor advertisement message generated by a second subscriber station in response to the first NDP message, to the first subscriber station using a unicast method,
wherein the first NDP message is a neighbor solicitation message being used to obtain a medium access control (MAC) address of the second subscriber station and includes a solicited-node multicast address.

9. The method of claim 1, wherein the first NDP message is a neighbor advertisement message being used to notify change of the MAC address of the first subscriber station and includes an all-node multicast address.

10. A computer readable recording medium having embodied thereon a computer program for executing the method of claim 1.
